(19) United States
(12) Patent Application Publication
(10) Pub. No.: US 2021/0304352 A1
(43) Pub. Date: Sep. 30, 2021

(54) MULTI-VIEW CONSISTENCY REGULARIZATION FOR SEMANTIC INTERPRETATION OF EQUAL-RECTANGULAR PANORAMAS

(71) Applicant: Robert Bosch GmbH, Stuttgart (DE)

(72) Inventors: Zhixin Yan, Sunnyvale, CA (US); Yuyan Li, Columbia, MO (US); Liu Ren, Cupertino, CA (US)

(21) Appl. No.: 16/836,290

(22) Filed: Mar. 31, 2020

(51) Int. Cl. G06T 3/00; G06N 20/00; G06N 3/08

(52) U.S. Cl. CPC G06T 3/0062; G06T 3/0093; G06N 3/08; G06N 20/00

(57) ABSTRACT

An artificial neural network is trained to produce spatial labelling for a three-dimensional environment based on image data. A two-dimensional image representation is produced of omni-direction image data captured by one or more cameras of the three-dimensional environment. The artificial neural network is applied using the two-dimensional image representation as input and producing a first predicted label as output. A rotated two-dimensional image is generated by shifting image pixels of the two-dimensional image representation in a horizontal direction. The artificial neural network is then applied again using the rotated two-dimensional image as input and producing a second predicted label as its output. The artificial neural network is trained based at least in part on a difference between the first predicted label and the second predicted label.

### BACKGROUND

The present invention relates to systems and methods for applying labels for image data using artificial neural networks and for training an artificial neural network to apply labels to the image data.

### SUMMARY

With technological breakthroughs in virtual and augmented reality, both the demands and amount of immersive content has been growing rapidly. One source of immersive content is 360-degree images and video. The 360 image, as its name suggests, captures omnidirectional visual information of surrounding environment. Understanding and extracting semantic information captured in 360 images has large potential, for example, in various business areas including augmented & virtual reality, building construction & maintenance, and robotics. One technique for representing 360 images is “equal-rectangular panorama” (ERP).

In some embodiments, ERP is used as input to a deep neural network that is trained to produce as output a room layout estimation, object detection, and/or object classification based on the ERP image data. Compared to conventional color images generated from perspective camera projection, ERP images are less sensitive to occlusion cases because the ERP images include 360-degree global information of the surround environment (e.g., a room). However, one downside of using ERP images is a lack of a sufficiently large amount of labelled data, which leads to limited performance of layout estimation. In some implementations, this limitation is addressed by utilizing multi-view consistency regularization, which leverages the rotation-invariance of layout in ERP images to reduce the need for large amounts of training data.

In various embodiments, the systems and methods described herein provide a novel regularization term to improve performance of deep neural networks for semantic interpretation of equal-rectangular panorama (ERP) images. Consistencies between different view of panorama images are utilized to reduce the amount of labelled ground truth data used for training of the deep neural network. This multi-view consistency regularization approach can be applied to various business areas including, for example, building construction & maintenance and augmented & virtual reality systems.

In one embodiment, the invention provides a method of training an artificial neural network to produce spatial labelling for a three-dimensional environment based on image data. A two-dimensional image representation is produced of omni-direction image data captured by one or more cameras of the three-dimensional environment. The artificial neural network is applied using the two-dimensional image representation as input and producing a first predicted label as output. A rotated two-dimensional image is generated by shifting image pixels of the two-dimensional image representation in a horizontal direction. The artificial neural network is then applied again using the rotated two-dimensional image as input and producing a second predicted label as its output. The artificial neural network is retrained based at least in part on a difference between the first predicted label and the second predicted label.

In another embodiment the invention provides system for producing spatial labelling for a three-dimensional environment based on image data using an artificial neural network. The system includes a camera system configured to capture omni-directional image data of the three-dimensional environment and a controller. The controller is configured to receive the omni-directional image data from the camera system and to produce a two-dimensional image representation of omni-direction image data. The controller then applies the artificial neural network using the two-dimensional image representation as input to produce a first predicted label as output. A rotated two-dimensional image is generated by shifting image pixels of the two-dimensional image representation in a horizontal direction. The artificial neural network is then applied again using the rotated two-dimensional image as input and producing a second predicted label as its output. The artificial neural network is retrained based at least in part on a difference between the first predicted label and the second predicted label.

In yet another embodiment, the invention provides a method of training an artificial neural network to produce a spatial labelling of layout boundaries for a three-dimensional environment based on image data. Spherical image data of the three-dimensional environment surrounding a camera system is captured by the camera system and a two-dimensional representation of the spherical image data is produced using equal-rectangular projection (ERP). The artificial neural network is applied using the two-dimensional image representation as input and producing a first predicted label as output. The artificial neural network is configured to produce as its output a predicted label defining layout boundaries for the three-dimensional environment based on equal-rectangular projection (ERP) image data received as the input. A multi-view consistency regularization loss term is determined by generating a rotated two-dimensional image (by moving a defined number of pixel columns from one horizontal end of the two-dimensional image representation to the other horizontal end) and applying the artificial neural network using the rotated two-dimensional image as input to produce a second predicted label as output. The multi-view consistency regularization loss term is determined based on a comparison of the first predicted label and the second predicted label. A task-specific loss term is determined based on a difference between the first predicted label and a ground truth label for the two-dimensional image representation and the artificial neural network is retrained based on both the task-specific loss term and the multi-view consistency regularization loss term.

Other aspects of the invention will become apparent by consideration of the detailed description and accompanying drawings.

### BRIEF DESCRIPTION OF THE DRAWINGS

FIG. 1 is a block diagram of a system for determining a map of layout boundaries using an artificial neural network and for training the artificial neural network according to one embodiment.

FIG. 2 is a method for mapping a layout of a room using the system of FIG. 1.

FIG. 3 is a graph example of mapping spherical image data into a 2D image file using equal-rectangular projection (ERP).

FIG. 4A is an example of a label defining layout boundaries for a room overlaid onto an ERP image of the room.

FIG. 4B is an example of the label and the ERP image of FIG. 4A rotated 90 degrees.

FIG. 5 is a functional block diagram illustrating a multi-view consistency regularization technique for determining additional loss function terms for training the artificial neural network in the system of FIG. 1 by rotating ERP image training data.

FIG. 6 is a flowchart of a method for training the artificial neural network using Multiview consistency regularization in the system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

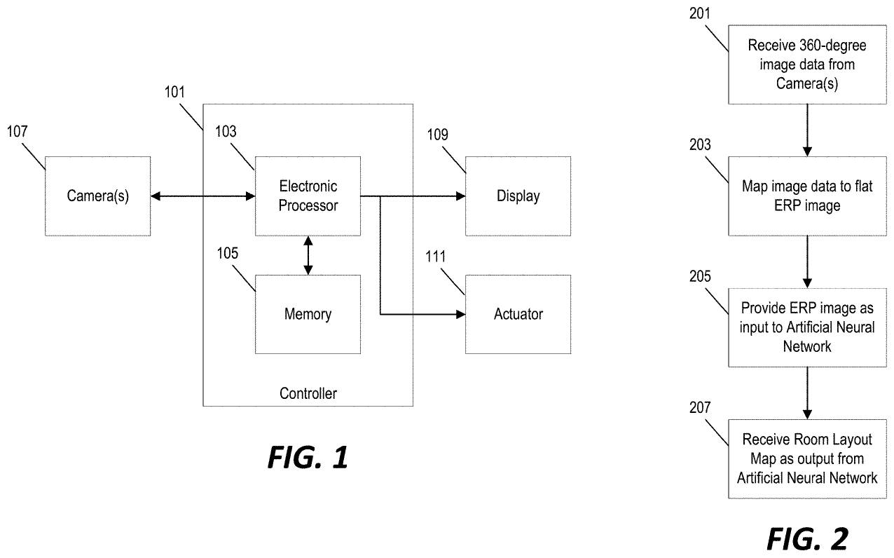

FIG. 1 illustrates an example of a system for determining labels for an environment based on image data. For example, in various implementations, the system of FIG. 1 may be configured to determine layout boundaries for a room, detect objects in a 3D environment, and/or classify (i.e., determine an identity of) objects in the 3D environment based on captured image data. The system includes a controller 101 with an electronic processor 103 and a non-transitory computer-readable memory 105. The memory 105 stores data and computer-executable instructions. The instructions stored on the memory 105 are accessed and executed by the electronic processor 103 to provide the functionality of the system such as described in the examples below.

The controller 101 is configured to receive image data from one or more cameras 107 that are communicative coupled to the controller 101. In some implementations, the one or more cameras 107 are configured to capture omni-directional image data including, for example, 360 images. The image data captured by the one or more cameras 107 is processed by the controller 101 in order to define labels for the surrounding environment. In some implementations, the controller 101 is also communicative coupled to a display 109 and is configured to cause the display 109 to display all or part of the captured image data and/or visual representations of the determined labels. In some implementations, the controller 101 is configured to show on the display 109 an “equal-rectangular panorama” (ERP) representation of the captured image data overlaid with the visual representation of the determined labels. In some implementations, the display 109 may also be configured to provide a graphical user interface for the system of FIG. 1.

In some implementations, the controller 101 is also communicative coupled to one or more actuators 111. The controller 101 is configured to provide control signals to operate the one or more actuators 111 based on the captured image data and/or the determined labels. For example, in some implementations, the actuators 111 may include electric motors for controlling the movement and operation of a robotic system. In some such implementations, the controller 101 may be configured to transmit control signals to the actuators 111 to maneuver the robot through a room based on a layout as determined based on the captured image data. Similarly, in some implementations where the controller 101 is configured to detect and classify objects in the surrounding environment based on the image data, the controller 1010 is further configured to transmit control signals to the actuators 111 to cause the robot to interact with one or more detected objects.

FIG. 2 illustrates an example of a method performed by the controller 101 for determining a room layout map as a “label” for captured image data using an artificial neural network. The controller 101 receives 360-degree image data from the one or more cameras 107 (step 201) and maps the captured image data to a flat ERP image (step 203). The ERP image is then used as input to an artificial neural network executed by the controller 101 (step 205). The output of the neural network generated in response to receiving the ERP image is a room layout map produced in the same ERP image format (step 207). In some implementations, the room layout map can then be reverse projected into 3D space based, for example, on the known mapping of the original 360 image data into the ERP image format.

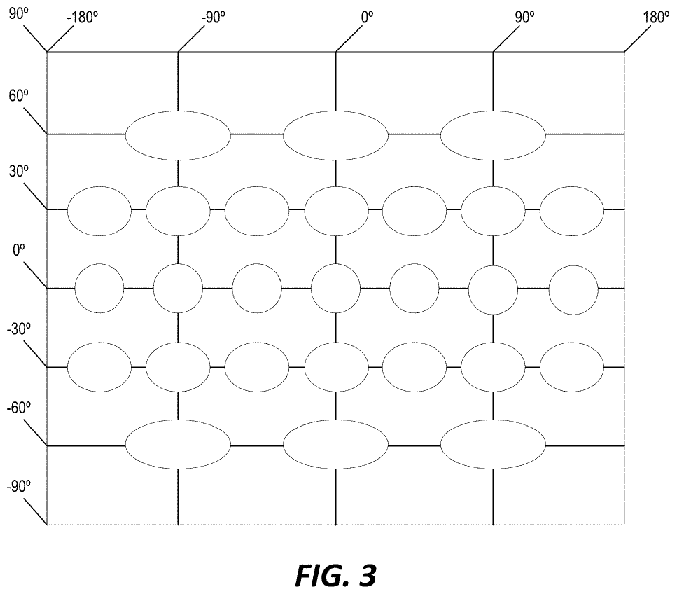

ERP images contain the 360-degree by 180-degree full visual information of an environment. Therefore, some ERP images may have a size of 2N×N, where N is the height of the image, so that each pixel can be mapped to the spherical space of (−180-degree to 180-degree)×(−90-degrees to 90-degrees). ERP images are created by projecting spherical space to 2D flat surfaces with equal-rectangular projection. The process of projecting spherical image data into a 2D rectangular space introduces “stretching” distorting in the horizontal direction at different locations in the vertical direction. This “stretching” distortion is illustrated in FIG. 3 where the ellipses show relative degrees of “stretching” of the image data from the original 360-image when projected into the 2D ERP image. Because image data at 90-degrees in the vertical direction represents the same single point in all horizontal directions, the degree to which the image data is “stretched” in the ERP projection image increases towards the upper and lower extremes of the ERP image. FIG. 3 illustrates this mapping by showing image data at 30-degrees in the vertical direction has a greater degree of “stretch” than image data at 0-degrees in the vertical direction.

Although the degree to which the image data in the ERP image is stretched in the horizontal direction varies based on the position of the image data in the vertical direction, the ERP image data does not exhibit similar distortions or “stretching” in the vertical direction. Accordingly, any rotations of the sphere in the horizontal direction simply results in a shifting of the image data to the left or right. For example, a 45-degree horizontal rotation of the ERP image data can be generated by cutting ⅛ of the ERP image data from the left of the ERP image and appending it to the right of the ERP image. This rotational characteristic applies, not only to the image data in the ERP image, but also to the ground-truth semantic labels applied to the image data.

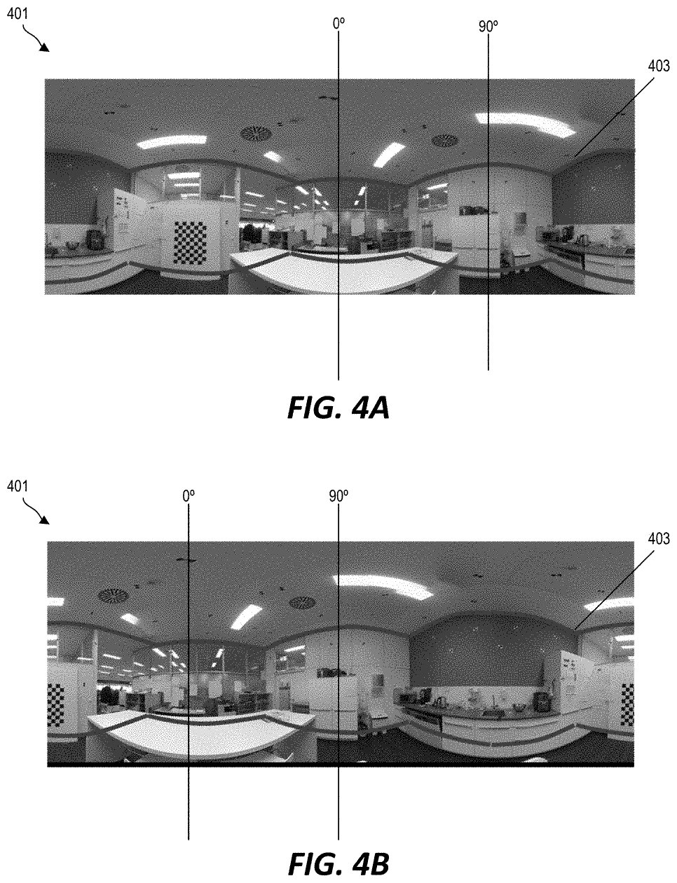

FIG. 4A shows an example of an ERP image 401 generated from 360-degree image data captured by the one or more cameras 107 in the system of FIG. 1 of a room in a house. A label 403 defining the “corner” boundaries in the room is overlaid onto the ERP image 401. Each line in the label 403 represents a detected edge between two wall surfaces in the room (i.e., an edge between a vertical wall and the ceiling, an edge between the vertical wall and the floor, and edges between adjacent vertical walls). FIG. 4B shows the same ERP image 401 shifted to the left to represent a 90-degree horizontal rotation of the 3D space. This rotation of the image data can be achieved by physically rotating the one or more cameras 107 and capturing new image data. Alternatively, as discussed above, the same rotation can be simulated by removing a portion of the image data from the left side of the ERP image 401 and appended to the right side of the ERP image 401. Once a label 403 is determined for the ERP image 401, the same label 403 can also be applied to the rotated ERP image 401 by similarly removing a portion of the label data from the left side of the 2D label 403 and appending it to the right side of the label 403.

The same image data in the ERP image 401 and the same portion of the label 403 that are displayed in the horizontal center of the ERP image 401 in FIG. 4A now appear at a location representative of 90-degrees to the left of center in FIG. 4B after the horizontal rotation. Similarly, the image data in the ERP image 401 and the portion of the label 403 that was displayed at 90-degrees to the right of center in the example of FIG. 4A appear at the center of the image in FIG. 4B after the rotation. As demonstrated by this example, the rotation of the label 403 and the ERP image 401 in this way does not change the correspondence of the label 403 to the ERP image 401.

Machine learning mechanisms such as the artificial neural network are “trained” based on a “training set” or “training data.” In some implementations, an artificial neural network is configured to produce an “output” in response to a received “input.” The artificial neural network is trained to minimize differences between the output produced by the artificial neural network and the “ground truth” output. The difference between the output of the artificial neural network and the “ground truth” output is called “loss.” Known algorithms can be used to train an artificial neural network by defining one or more “loss functions” expressing this “loss.”

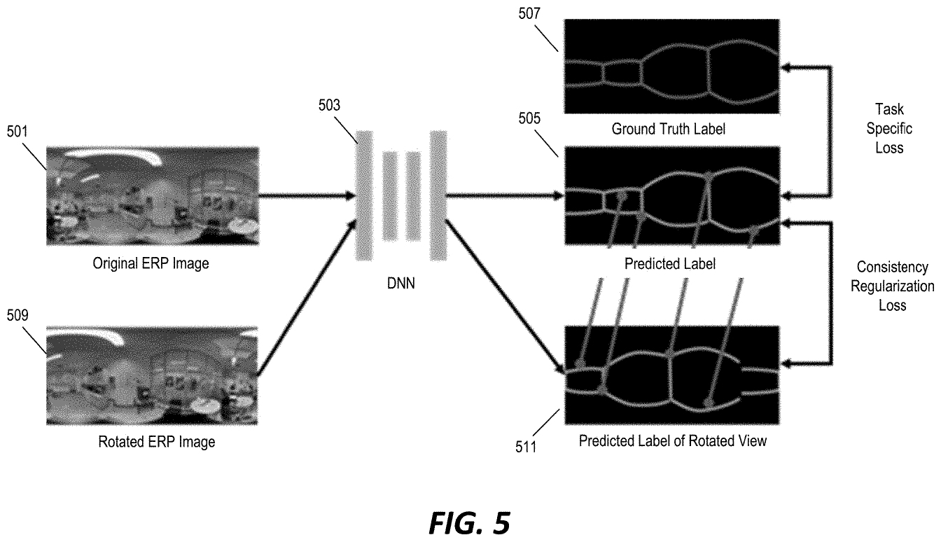

FIG. 5 illustrates an example of an approach for training an artificial neural network to determine a label in response to a captured ERP image. In the example of FIG. 5, the artificial neural network is a “deep neural network” (DNN) configured to produce as output a label defining the locations of “corners” between two adjacent surfaces (i.e., walls, ceiling, floor) in a room. As illustrated in FIG. 5, an original ERP image 501 is provided as the input to the DNN 503 and a first predicted label 505 is produced as the output of the DNN 503. The first predicted label 505 is compared to a ground truth label 507. The ground truth label 507 is a representation of the “correct” label that the DNN 503 would produce if ideally trained. In some implementations, the ground truth label 507 is produced for the original ERP image 501 using techniques other than the DNN 503. For example, the ground truth label 507 is produced in some implementations by manually defining the corner mapping layout for the room.

Differences between the first predicted label 505 and the ground truth label 507 are referred to as “task specific loss” (i.e., the difference between the actual output of the DNN 503 and an ideal “correct” output). This task specific loss can then be used as to define the loss function that will be used to train the DNN 503. However, to improve the training of the DNN 503, the mechanism illustrated in FIG. 5 utilizes multi-view consistency regularization to define an additional loss function for training of the DNN 503.

The original ERP image 501 is “rotated” by removing a portion of the image data from one side of the ERP image 501 and appending it to the other side of the ERP image 501 to create a rotated ERP image 509. The rotated ERP image 509 is then provide as input to the DNN 503 and a second predicted label 511 (i.e., a predicted label of the rotated view of the ERP image) is produced as the output of the DNN 503. As discussed above, both the ERP image itself and the “label” can be rotated by moving image data from one side of the 2D image to the other. Accordingly, in an ideally trained DNN 503, the difference between the first predicted label 505 and the second predicted label 511 should be a shift of the label by a known degree (corresponding to the shift of pixels in the ERP image data). Any differences between the first predicted label 505 and the second predicted label 511 other than this expected shift in the horizontal direction (i.e., “consistency regularization loss”) is then used to define an additional loss function that can also be used to train the DNN 503.

In addition to providing an additional loss function that can be used to train the DNN 503, the number of loss terms that can be determined from a single ERP image is significantly increased by using this simulated rotation of the ERP image data. The number of different rotationally “shifted” images that can be produced from a single ERP image is limited only by the horizontal resolution of the ERP image. Therefore, a relatively large number of “consistency regularization loss” terms can be determined from a single ERP image (i.e., at least one for each shift in the horizontal direction). Additionally, because the ground truth label 507 can also be shifted to the same degree as the rotated ERP image 509, in some implementations, the second predicted label 511 is then compared to a correspondingly shifted ground truth label 507 to produce additional task specific loss terms.

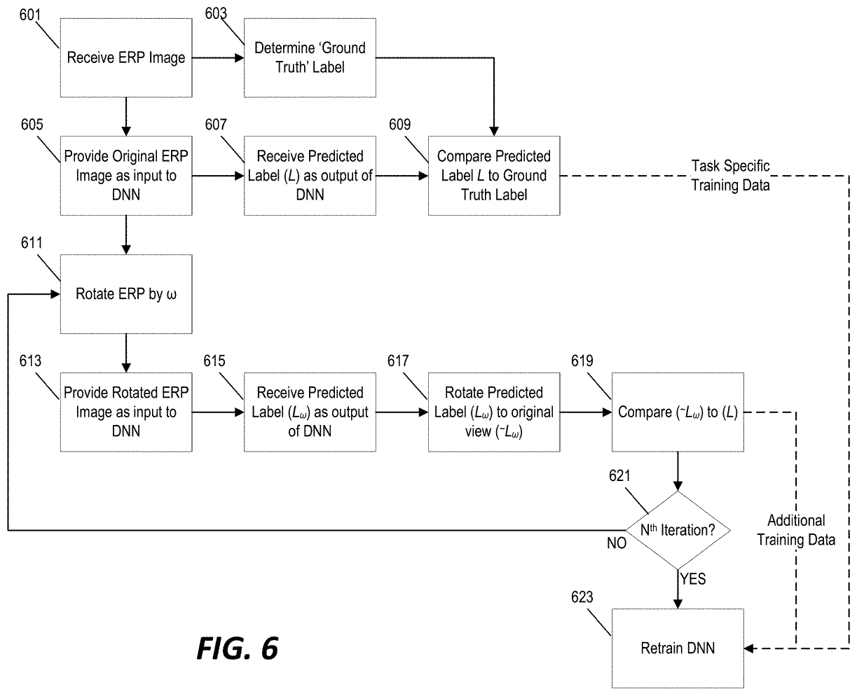

FIG. 6 illustrates one example of a method implemented by the controller 101 of FIG. 1 to train the DNN 503 using the mechanism illustrated in FIG. 5. An original ERP image is received (or produced) by the controller 101 (step 601) and a “ground truth” label is determined for the original ERP image (for example, by manually labelling the “corners” of the room in the original ERP image) (step 603). The ERP image is then provided as input to the DNN 503 (step 605) and a predicted label (L) is produced as the output of the DNN 503 (step 607). The predicted label L is then compared to the ground truth label (step 609) to produce “task specific training data.”

The original ERP image is then shifted based on a defined rotation angle ω (step 611). In some implementations, the defined rotation angle ω is determined based on the number of different view N to be processed for multi-view consistency regularization loss such that the angle ω can be sampled uniformly by dividing 360-degrees by N. In other implementations, the system may be configured to select one or more rotation angles co randomly between −180-degrees and 180-degrees.

The rotated ERP image is then provided as input to the DNN 503 (step 613) and an additional predicted label L_{ω} for the rotated ERP image is produced as the output of the DNN 503 (step 615). This new predicted label L_{ω} is then rotated back to the perspective of the original ERP image (step 617). This reverse rotated additional predicted label [symbol] is then compared to the predicted label from the original ERP image L (step 619) to produce the additional training data (i.e., a multi-view consistency regularization loss term). This shifting of the ERP image data (step 611), reverse shifting of the predicted label (step 617), and comparison of the predicted labels (step 619) is repeated until the Nth iteration (step 621). After the Nth iteration (step 621), the DNN 503 is retrained based on the task specific training data and the additional training data (step 623). By adding an additional multi-view consistency regularization loss term/function during training, the system is able to train the DNN 503 to produce consistent results regardless of the physical rotational position of the camera and thereby prevents the DNN 503 from overfitting to certain camera views.

Thus, the invention provides, among other thing, systems and methods for training an artificial neural network to define labels for a three-dimensional environment based on omni-directional image data mapped in equal-rectangular panorama by using multi-view consistency regularization as a loss function for training the artificial neural network. Additional features and aspects of this invention are set forth in the following claims.

What is claimed is:

1. A method of training an artificial neural network to produce spatial labelling for a three-dimensional environment based on image data, the method comprising:
producing a two-dimensional image representation of omni-directional image data of the three-dimensional environment captured by one or more cameras;
applying the artificial neural network using the two-dimensional image representation as input to produce a first predicted label, wherein the artificial neural network is configured to produce the spatial labelling for the three-dimensional environment for image data received as the input;
generating a rotated two-dimensional image by shifting image pixels of the two-dimensional image representation in a horizontal direction;
applying the artificial neural network using the rotated two-dimensional image as the input to produce a second predicted label; and
retraining the artificial neural network based at least in part on a difference between the first predicted label and the second predicted label.

2. The method of claim 1, wherein generating the rotated two-dimensional image includes generating a first rotated two-dimensional image by shifting the image pixels of the two-dimensional image representation in the horizontal direction by a first define shift amount, the method further comprising:
generating a second rotated two-dimensional image by shifting the image pixels of the two-dimensional image representation in the horizontal direction by a second defined shift amount, the second defined shift amount being different from the first defined shift amount; and
applying the artificial neural network using the second rotated two-dimensional image as the input to produce a third predicted label,
wherein retraining the artificial neural network includes retraining the artificial neural network based at least in part on differences between the first predicted label, the second predicted label, and the third predicted label.

3. The method of claim 1, further comprising capturing the omni-directional image data using one or more cameras configured to capture 360-degree image data in a three-dimensional environment surrounding the one or more cameras, wherein generating the rotated two-dimensional image includes
removing a portion of the image data from a first horizontal end of the two-dimensional image representation, and
appending the removed portion of the image data to a second horizontal end of the two-dimensional image representation, the second horizontal end being opposite the first horizontal end.

4. The method of claim 1, further comprising capturing the omni-directional image data using one or more cameras configured to capture spherical image data in a three-dimensional environment surround the one or more cameras, wherein producing the two-dimensional image representation of the omni-directional image data includes mapping the spherical image data to the two-dimensional image representation using equal-rectangular panorama projection.

5. The method of claim 1, wherein applying the artificial neural network using the rotated two-dimensional image as the input to produce the second predicted label includes applying the artificial neural network using the two-dimensional image representation as the input to produce the second predicted label defining layout boundaries in the three-dimensional environment, wherein the layout boundaries of the second predicted label are defined in a two-dimensional format corresponding to the format of the rotated two-dimensional image.

6. The method of claim 5, further comprising quantifying the difference between the first predicted label and the second predicted label by
shifting image pixels of the second predicted label in a reverse horizontal direction to align the second predicted label with the first predicted label, and
comparing the shifted second predicted label to the first predicted label.

7. The method of claim 1, further comprising:
determining a ground truth label for the two-dimensional image representation of the three-dimensional environment;
determining a task-specific loss term by comparing the ground truth label and the first predicted label; and
determining an additional loss term by comparing the first predicted label and the second predicted label,
wherein retraining the artificial neural network based at least in part on the difference between the first predicted label and the second predicted label includes retraining the artificial neural network based on the task-specific loss term and the additional loss term.

8. A system for producing spatial labelling for a three-dimensional environment based on image data using an artificial neural network, the system comprising:
a camera system configured to captured omni-directional image data of the three-dimensional environment; and
a controller configured to
receive the omni-directional image data captured by the camera system,
produce a two-dimensional image representation of the omni-directional image data of the three-dimensional environment,
apply the artificial neural network using the two-dimensional image representation as input to produce a first predicted label, wherein the artificial neural network is configured to produce the spatial labelling for the three-dimensional environment for image data received as the input,
generate a rotated two-dimensional image by shifting image pixels of the two-dimensional image representation in a horizontal direction,
apply the artificial neural network using the rotated two-dimensional image as the input to produce a second predicted label, and
retrain the artificial neural network based at least in part on a difference between the first predicted label and the second predicted label.

9. The system of claim 8, wherein the controller is configured to generate the rotated two-dimensional image by generating a first rotated two-dimensional image by shifting the image pixels of the two-dimensional image representation in the horizontal direction by a first define shift amount,
wherein the controller is further configured to
generate a second rotated two-dimensional image by shifting the image pixels of the two-dimensional image representation in the horizontal direction by a second defined shift amount, the second defined shift amount being different from the first defined shift amount, and
apply the artificial neural network using the second rotated two-dimensional image as the input to produce a third predicted label, and
wherein the controller is configured to retrain the artificial neural network by retraining the artificial neural network based at least in part on differences between the first predicted label, the second predicted label, and the third predicted label.

10. The system of claim 8, wherein the camera system is configured to capture the omni-directional image data by capturing 360-degree image data in a three-dimensional environment surrounding the camera system, and wherein the controller is configured to generate the rotated two-dimensional image by
removing a portion of the image data from a first horizontal end of the two-dimensional image representation, and
appending the removed portion of the image data to a second horizontal end of the two-dimensional image representation, the second horizontal end being opposite the first horizontal end.

11. The system of claim 8, wherein the camera system is configured to capture the omni-directional image data by capturing spherical image data in a three-dimensional environment surround the one or more cameras, wherein the controller is configured to produce the two-dimensional image representation of the omni-directional image data by mapping the spherical image data to the two-dimensional image representation using equal-rectangular panorama projection.

12. The system of claim 8, wherein the controller is configured to apply the artificial neural network using the rotated two-dimensional image as the input to produce the second predicted label by applying the artificial neural network using the two-dimensional image representation as the input to produce the second predicted label defining layout boundaries in the three-dimensional environment, wherein the layout boundaries of the second predicted label are defined in a two-dimensional format corresponding to the format of the rotated two-dimensional image.

13. The system of claim 12, wherein the controller is further configured to quantify the difference between the first predicted label and the second predicted label by
shifting image pixels of the second predicted label in a reverse horizontal direction to align the second predicted label with the first predicted label, and
comparing the shifted second predicted label to the first predicted label.

14. The system of claim 8, wherein the controller is further configured to:
determine a ground truth label for the two-dimensional image representation of the three-dimensional environment,
determine a task-specific loss term by comparing the ground truth label and the first predicted label, and
determine an additional loss term by comparing the first predicted label and the second predicted label, and
wherein the controller is configured to retrain the artificial neural network based at least in part on the difference between the first predicted label and the second predicted label by retraining the artificial neural network based on the task-specific loss term and the additional loss term.

15. A method of training an artificial neural network to produce a spatial labelling of layout boundaries for a three-dimensional environment based on image data, the method comprising:
capturing, by a camera system, spherical image data of the three-dimensional environment surrounding the camera system;
producing a two-dimensional image representation of the spherical image data using equal-rectangular panorama projection;
applying the artificial neural network using the two-dimensional image representation as input to produce a first predicted label, wherein the artificial neural network is configured to produce a predicted label defining layout boundaries for the three-dimensional environment based on the image data received as the input;
determining a multi-view consistency regularization loss term by
generating a rotated two-dimensional image by removing a defined number of pixel columns from a first horizontal end of the two-dimensional image representation and appending the removed pixel columns to a second horizontal end of the two-dimensional image representation,
applying the artificial neural network using the rotated two-dimensional image as input to produce a second predicted label, and
comparing the first predicted label and the second predicted label to determine the multi-view consistency regularization loss term based on a difference between the first predicted label and the second predicted label;
determining a task-specific loss term based on a different between the first predicted label and a ground truth label for the two-dimensional image representation; and
retraining the artificial neural network based at least in part on the multi-view consistency regularization loss term and the task-specific loss term.
